(19) United States
(12) Patent Application Publication
(10) Pub. No.: US 2024/0317558 A1
(43) Pub. Date: Sep. 26, 2024

(54) SELF-PROPELLING PIECE OF LIFTING MACHINERY HAVING A MAIN ELECTRICAL POWER SOURCE AND ABLE TO ACCOMMODATE VARIOUS INTERCHANGEABLE SECONDARY ELECTRICAL POWER SOURCES

(71) Applicant: HAULOTTE GROUP, LORETTE (FR)

(72) Inventors: Olivier GUILLERMIN, SAINT-JUST-SAINT-RAMBERT (FR); Jean-Baptiste DORAY, CHASSE-SUR-RHONE (FR); Nicolas DUMONT, CALUIRE (FR)

(73) Assignee: HAULOTTE GROUP, LORETTE (FR)

(21) Appl. No.: 18/577,829

(22) PCT Filed: Jul. 20, 2022
(86) PCT No.: PCT/FR2022/051446

§ 371 Date: Jan. 9, 2024

(30) Foreign Application Priority Data
Jul. 21, 2021 (FR) FR2107877
Jul. 21, 2021 (FR) FR2107888

(51) Int. Cl. B66F 9/24; B60L 50/60; B60L 53/51; B60L 53/54; B60L 53/65; B60L 53/80; B66F 9/065; B66F 11/04

(52) U.S. Cl. CPC B66F 9/24; B60L 50/60; B60L 53/65; B60L 53/80; B60L 53/51; B60L 53/54; B60L 2200/40; B60L 2200/42; B66F 9/0655; B66F 11/042

(57) ABSTRACT

This piece of machinery (1) comprises a system for lifting people or loads (5) and a first stand-alone electrical power source that is used to make the piece of machinery function. A second location (8) allows an optional second stand-alone electrical power source (15) to be removably accommodated. The latter is selectable from a plurality of different second sources not exclusively made up of engine generators and not exclusively made up of devices for storing electrical power. It for example allows the first stand-alone electrical power source to be recharged or the piece of machinery to be powered together therewith. The piece of machinery comprises a system for identifying the second stand-alone electrical power source among the plurality of second sources accommodated in the second location (8). On-board electronics manage the delivery of electrical power to the piece of machinery by the second source depending on the second source identified.

### BACKGROUND OF THE INVENTION

### Field of the Invention

The present invention relates to the field of machines for lifting persons or loads of the self-propelled type operating with electrical power. More particularly, the invention relates to lifting machines provided with an electrical power source such as a pack of rechargeable electric batteries and at least one electric motor for moving the lifting vehicle on the ground and operating a system for lifting persons or loads.

It may in particular be mobile elevating work platforms (abbreviated MEWP), also commonly called aerial work platforms (abbreviated AWP). It may also be telehandlers.

### Brief Description of the Related Art

Todays' trend is to design person or load lifting machines of the self-propelled type which are electrically operated, even when they are provided for outdoor use, for reasons of limiting environmental and noise pollution with respect to those operating with an internal combustion engine.

A difficulty with electrically operating self-propelled lifting machines is their working autonomy especially in outdoor use, in particular regarding the size of the rechargeable electric batteries that it is possible to install on the lifting machine, variable environmental conditions, in particular in terms of temperature, which can be unfavorable to electrical batteries, as well as insufficient accessibility to a power supply network for recharging the batteries.

With respect to this difficulty, the applicant has proposed in WO 2020/157094 A2 an improved design of an electrically operating self-propelled aerial work platform that can be used outdoors. The latter is provided with rechargeable electric batteries for powering the electric motors used for lifting its working platform and for moving the aerial work platform on the ground and one or more chargers for recharging the batteries from a power supply network. It further comprises a location provided for removably receiving a generating set for recharging the batteries by means of one or more of the chargers of the aerial work platform.

While the use of a removable generating set makes it possible to increase the autonomy of the aerial work platform, it has, however, the draw back of being a source of environmental and noise pollution. This also makes it difficult to use indoors.

### SUMMARY OF THE INVENTION

One aim of the present invention is to further improve the existing self-propelled lifting machines of electric type so as to be able to benefit from additional electrical power in various situations of use.

To this end, the present invention proposes, according to a first aspect, a person or load lifting machine, comprising a system for lifting persons or loads, an electric power circuit comprising at least one electric motor for actuating the lifting system and moving the lifting machine on the ground, and at least a first self-contained electrical power source received in a first location of the lifting machine, the lifting machine being provided to operate by being powered solely by the first self-contained electrical power source. The first self-contained electrical power source is preferably a first rechargeable electrical battery pack, but it may be a self-contained electrical power source of another type. The lifting machine further comprises a second location distinct from the first location and provided to removably receive a second self-contained electrical power source distinct from the first source of electrical power which second self-contained electrical power source is selectable from a plurality of different second self-contained electrical power sources not exclusively consisting of generating sets and not exclusively consisting of electrical power storage devices. The lifting machine comprises an electrical connection system adapted to connect any one of the plurality of second self-contained electrical power sources thereto when received in the second location so as to enable the second self-contained electrical power source to supply electrical power to the power circuit. The lifting machine further comprises an identification system provided to identify which of the plurality of second self-contained electrical power sources is received in the second location. Finally, the lifting machine comprises onboard electronics provided to manage the supply of electrical power to the power circuit by the second self-contained electrical power source depending on the second self-contained electrical power source identified by the identification system.

It will be understood that the second self-contained electrical power sources are qualified as self-contained because they can each be used to supply electrical power independently of the lifting machine. All what is necessary for its operation is included with the power source itself, which makes it able to be used moreover independently of the lifting machine. Because different second self-contained electrical power sources can be used with the lifting machine, it is possible to use that which is the most adapted according to the circumstances, for example depending on whether the use of the machine is outdoors or indoors, or also depending on the primary energy source(s) available locally to operate corresponding second self-contained electrical power sources such as, for example, a power grid, fuels that may be of different natures, solar energy, etc. This provides greater versatility and adaptability to the lifting machine.

Advantageously, it may be provided that at least one of the second self-contained electrical power sources is an electrical power storage device that is rechargeable by a separate electrical power source and that at least one other of the second self-contained electrical power sources is a device which is unable to store electrical energy in a rechargeable manner from a separate power source, but which outputs electrical energy by transforming a non-electrical energy source into electrical energy. The plurality of second self-contained electrical power sources may comprise several different sources pertaining to one and/or the other of these two categories, thereby increasing the versatility and adaptability of the lifting machine. More generally, it is advantageous to provide for the lifting machine to be able to receive second self-contained electrical power sources that are of different nature.

According to preferred embodiments, the lifting machine according to the invention comprises one or more of the following features.

The lifting machine may further comprise an electrical adaptation system for adapting electrical characteristics of the electrical energy supplied to the power circuit by at least one of the plurality of self-contained electrical power sources when it is connected to the electrical connection system.

The onboard electronics may be provided to cause the electrical adaptation system to adapt or not to adapt electrical characteristics of the electrical power supplied to the power circuit by the second self-contained electrical power source depending on the self-contained electrical power source identified by the identification system.

According to an advantageous embodiment, provision is made for the second self-contained electrical power source to be selectable from a plurality of different second self-contained electrical power sources, at least one of which outputs a DC voltage and at least one other outputs an AC voltage. This further enhances the versatility and adaptability of the lifting machine.

Even more advantageously, provision is made for the second self-contained electrical power source to be selectable from a plurality of different second self-contained electrical power sources, at least one of which outputs a DC voltage, at least one other exclusively outputs a single-phase AC voltage and at least one other outputs a three-phase AC voltage.

In these embodiments, the electrical adaptation system is provided to adapt the voltage output by a second self-contained electrical power source to the operating voltage of the power circuit of the lifting machine. Of course, this adaptation is carried out by the electrical adaptation system only for those of the second self-contained electrical power sources for which such adaptation is appropriate. This voltage adaptation may relate to both the nature of the voltage and the voltage level.

For example, in a preferred embodiment in which the power circuit of the lifting machine is designed to be powered with a DC voltage, the electrical adaptation system converts the AC voltage output by the relevant one(s) of the second self-contained electrical power sources to a DC voltage suitable for the power circuit. In this preferred embodiment, the electrical adaptation system may also be provided to adapt the level of the DC voltage output by the relevant one(s) of the second self-contained electrical power sources to a DC voltage at the appropriate level for the power circuit.

To this end, the electrical adaptation system may comprise at least one AC/DC converter and/or at least one DC/DC converter.

The electrical adaptation system can advantageously be provided to be able to adapt several different levels of DC voltage, or any voltage comprised in a DC voltage range, to the operating voltage of the power circuit of the machine.

Similarly, the electrical adaptation system can advantageously be provided to be able to adapt several levels of different AC voltages, or any voltage comprised in an AC voltage range, with the operating voltage of the power circuit of the machine. This can be provided for single-phase AC voltages and/or for three-phase AC voltages.

This allows the machine to receive, in the second location, second self-contained electrical power sources outputting each a different DC voltage or a different AC voltage.

This further enhances the versatility and adaptability of the lifting machine.

The identification system may comprise a data communication device adapted to establish a data communication link with any one of the plurality of second self-contained electrical power sources when received in the second location, the onboard electronics being provided to cooperate with the data communication device so as to obtain from the second self-contained electrical power source identification data thereof.

The lifting machine may be provided to be able to load the first self-contained electrical power source from the electrical power supplied by the second self-contained electrical power source. The onboard electronics may be provided to adapt the load curve of the first self-contained electrical power source depending on the second self-contained electrical power source identified by the identification system. Alternatively or additionally, the lifting machine may be provided to be able to power the at least one electric motor simultaneously from the first self-contained electrical power source and the second self-contained electrical power source.

The lifting machine may in particular be provided to allow an operator to choose between charging the first self-contained electrical power source with the electrical power supplied by the second self-contained electrical power source and supplying the at least one electric motor simultaneously from the first self-contained electrical power source and the second self-contained electrical power source.

In the preceding embodiment, the lifting machine is provided to supply the second self-contained electrical power source with a higher power, for example the double, when the operator chooses to have the at least one electric motor supplied simultaneously by the first self-contained electrical power source and the second self-contained electrical power source with respect to the case where the operator chooses to have the first self-contained electrical power source charged with the electrical power supplied by the second self-contained electrical power source.

At least one second self-contained electrical power source among the plurality of the second self-contained electrical power sources may comprise a start-up function to be able to supply electrical power and/or a shut-down function to end the supply of electrical energy, the onboard electronics being provided for controlling the starting and/or stopping of this second self-contained electrical power source.

The plurality of second self-contained electrical power sources comprises one or more of the following self-contained electrical power sources: a generating set: a fuel cell: a second pack of rechargeable electric batteries: a solar energy panel. More particularly, the plurality of second self-contained electrical power sources may comprise one or more of the following self-contained electrical power sources: an internal combustion generating set: a gas turbine generating set: a hydrogen fuel cell: a second pack of electrical batteries with an associated electrical charger for recharging them: a second pack of electric batteries without an associated electric charger for recharging them: a solar energy panel.

It is particularly advantageous for one of the plurality of self-contained second electrical power sources to be a fuel cell, preferably a hydrogen fuel cell, given its non-polluting nature. For the same reason, it is particularly advantageous for one of the plurality of self-contained second electrical power sources to be a solar energy panel.

The second location may be provided with means for cooperating with any of the second self-contained electrical power sources to position and removably hold the second self-contained electrical power source in position in or on the second location, which means are the same for each of the plurality of second self-contained electrical power sources. In other words, the machine is designed to allow positioning and holding in position a second self-contained electrical power source in or on the second location in a manner that is common to all of the second self-contained electrical power sources.

The electrical connection system may comprise a power connector to which any one of the second self-contained electrical power sources can be connected. The electrical connection system can thus comprise a single power connector which is common to all the second self-contained electrical power sources, even if they deliver voltages of different nature such as a DC voltage or a single-phase and/or three-phase AC voltage.

The lifting machine may in particular be a telehandler or an aerial work platform.

According to a second aspect, the invention proposes a set of several different self-contained electrical power sources not exclusively consisting of generating sets and not exclusively consisting of electrical power storage devices, each of the self-contained electrical power sources being provided to be received in the second location of a same lifting machine according to the aforementioned first aspect of the invention and to be connected to the electrical connection system of the lifting machine as a said second self-contained electrical power source.

According to an advantageous embodiment, this set of several different self-contained electrical power sources comprises at least one self-contained electrical power source outputting a DC voltage and at least one other self-contained electrical power source outputting an AC voltage.

Even more advantageously, this set of several different self-contained electrical power sources comprises at least one self-contained electrical power source outputting a DC voltage, at least one other self-contained electrical power source exclusively outputting a single-phase AC voltage and at least one other self-contained electrical power source outputting a three-phase AC voltage.

According to yet another advantageous embodiment, this set of several different self-contained electrical power sources comprises several self-contained electrical power sources outputting each a different DC voltage.

According to yet another advantageous embodiment, this set of several different self-contained electrical power sources comprises several self-contained electrical power sources exclusively outputting a respectively different single-phase AC voltage.

According to yet another advantageous embodiment, this set of several self-contained electrical power sources comprises several self-contained electrical power sources outputting a different three-phase AC voltage.

According to other preferred embodiments, this set of several different self-contained electrical power sources comprises one or more of the following characteristics.

Each of the self-contained electrical power sources may comprise identical means serving to put it into position and to removably hold it in position in the second location of the lifting machine.

Each of the sources may comprise an identical housing in which its components are housed.

The set of several different self-contained electrical power sources may comprise one or more of the following self-contained electrical power sources: a generating set: a fuel cell: a second pack of rechargeable electric batteries: a solar energy panel. Even more preferably, the set may comprise one or more of the following self-contained electrical power sources: an internal combustion generating set: a gas turbine generating set: a hydrogen fuel cell: a second pack of electric batteries with an associated electrical charger for recharging them: a second pack of electric batteries without an associated electric charger for recharging them: a solar energy panel.

It is advantageous for this set of several different self-contained electrical power sources to comprise at least one preferably hydrogen fuel cell and/or a solar energy panel.

According to a third aspect, the invention proposes a set comprising a lifting machine according to the first aspect of the invention and a set of several self-contained electrical power sources according to the second aspect of the invention which are each provided to serve as a said second self-contained electrical power source for the lifting machine.

According to a fourth aspect, the invention proposes a method for operating a lifting machine according to the first aspect of the invention, the method comprising providing a set of several different self-contained electrical power sources according to the second aspect of the invention for selectively using any one of them with the lifting machine as a said second self-contained electrical power source.

Other aspects, features and advantages of the invention will become apparent on reading the following description of two preferred embodiments of the invention, given by way of example and with reference to the appended drawing.

### BRIEF DESCRIPTION OF THE FIGURES

FIG. 1 shows a perspective view of a telehandler according to an embodiment of the invention which is equipped with a second self-contained electrical power source removably mounted on a location of the telehandler which is provided for this purpose.

FIG. 2 shows the same telehandler as the preceding figure, but without the second self-contained electrical power source.

FIG. 3 shows a block diagram of the electric circuit of the telehandler of FIGS. 1 and 2.

FIG. 4 shows a scissor lift according to an embodiment of the invention, the scissor lift mechanism of which is in the deployed state.

FIG. 5 shows the other side of this scissor lift where a location is arranged for removably receiving a second self-contained electrical power source, the scissor lift mechanism being in the retracted state.

FIG. 6 shows the scissor lift of FIGS. 4 and 5 with a second self-contained electrical power source received in the location provided for this purpose.

### DETAILED DESCRIPTION OF THE INVENTION

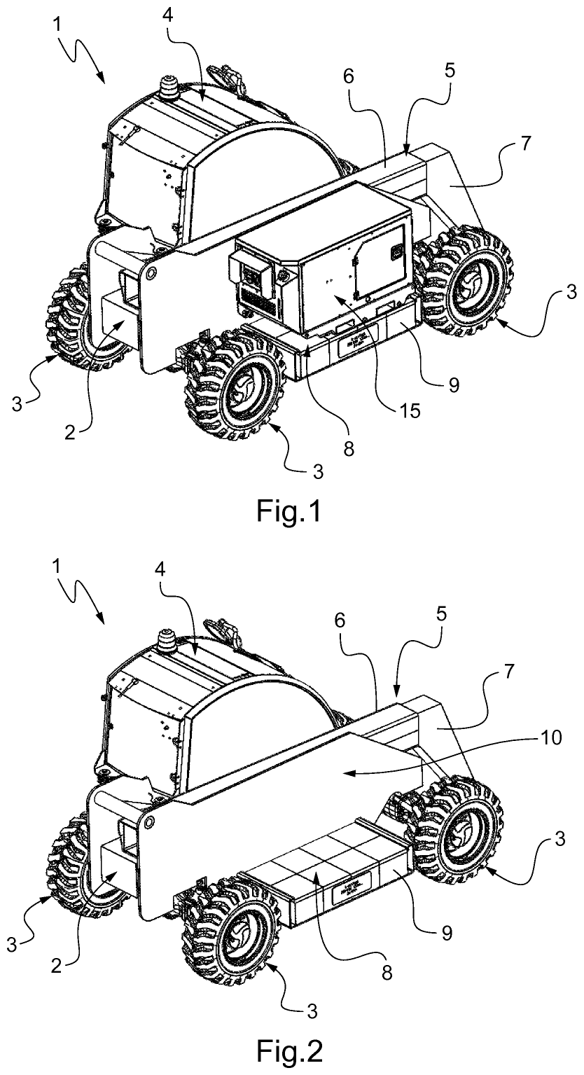

FIGS. 1 and 2 show a telehandler 1 according to one embodiment of the invention. The telehandler 1 comprises a chassis 2 which rests on the ground by wheels 3 allowing it to move on the ground. It comprises a driving cabin 4 for accommodating an operator and a lifting system 5. The lifting system 5 comprises a telescopic arm including at least two sections sliding relative to each other. The lower segment 6 is pivotally mounted about a horizontal axis on the chassis 2 while the upper segment 7 has a free end provided for mounting thereon an element or support (not illustrated in FIGS. 1 and 2) intended to receive loads and/or persons such as a fork or a working platform.

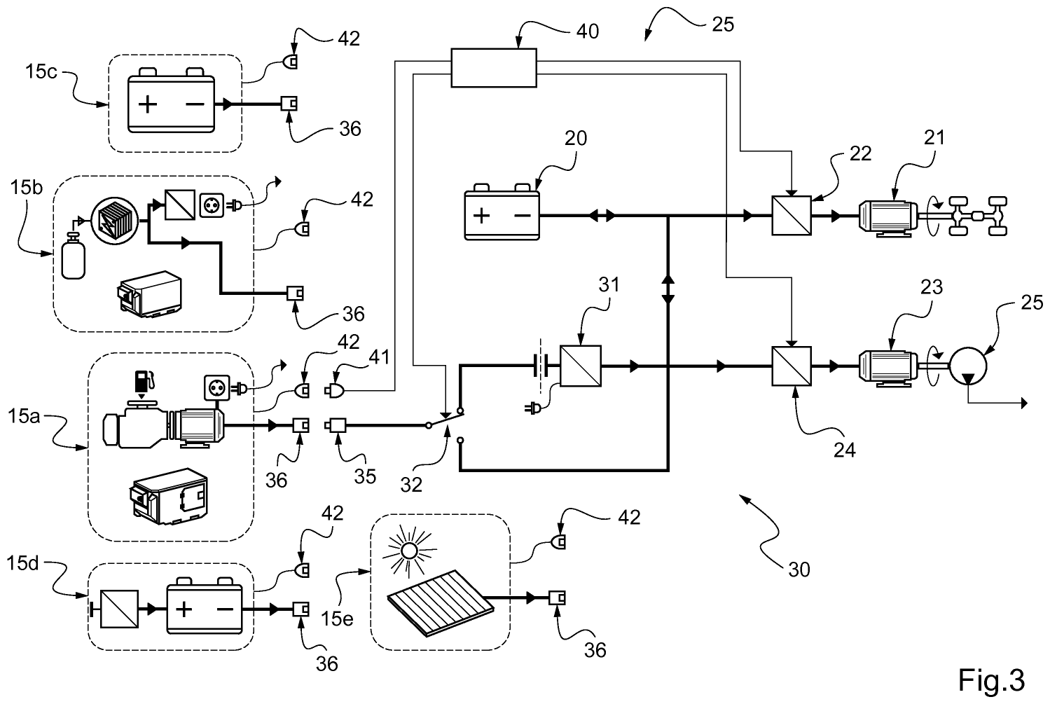

The telehandler 1 is of the electrical type. It comprises an electric motorization for its movement on the ground and for actuating the lifting system 6. This motorization is powered by a pack of rechargeable electric batteries. The battery pack is mounted in a first dedicated location located under the cabin 4 as well as the motorization: therefore, they are not visible in FIGS. 1 and 2. In FIG. 3 which will be described below, this battery pack is referenced 20. It is provided as a main power source for supplying the telehandler 1. Alternatively, this main source of electrical power may be another self-contained electrical power source such as a hydrogen fuel cell.

The telehandler 1 comprises a second location 8 provided to receive in a removable manner a second self-contained electrical power source 15. The second location 8 is distinct from the first location receiving the battery pack 20 and the second self-contained electrical power source 15 is distinct from the battery pack 20. The second location 8 is located in this example on the chassis 2 on a lateral side opposite the cabin 4, the lifting system 5 in the form of a telescopic arm being placed between the cabin 4 and the second location 8. In this example, the second location 8 is defined by a horizontal support plate 9 and a vertical wall 10.

As will be seen below, the second self-contained electrical power source 15 is selectable from a plurality of different self-contained electrical power sources, each of them being provided to be received in the second location 8. In particular, these may be, without being limited thereto, the following sources: a generating set, a fuel cell, preferably a hydrogen fuel cell, a second pack of rechargeable electric batteries, a solar energy panel.

This list is not limiting, and other self-contained electrical power sources can be proposed as a second self-contained electrical power source.

As emerges from these examples, these second self-contained electrical power sources may be either electrical power storage devices or devices that are unable to store electrical energy, but which transform a non-electrical primary energy source into electrical energy.

As regards the generating set, it may be more particularly a generating set with an internal combustion engine, preferably a diesel engine. It may also be a gas turbine generating set. The generating set may in particular be of the type supplying a single-phase AC voltage as output or of the type supplying a three-phase AC voltage.

It will be understood that the lifting machine 1 can be provided to receive different models of generating sets that have different characteristics in terms of motorization and/or electrical characteristics of the electrical power output. More generally, the lifting machine 1 may be provided to receive different models for a given type of second self-contained electrical power source, for example different fuel cell models or different battery packs.

The second location 8 and the second self-contained electrical power sources 15 are designed to ensure the positioning and the holding in position in a removable manner of any of the second self-contained power sources in or on the second location 8. It is advantageous to provide that all of the second self-contained electrical power sources 15 have identical means for positioning them and holding them in position in the second location 8 by cooperation in each case with common corresponding means of the second location 8.

Unlike the battery pack 20 which is not intended to be often removed from the telehandler 1, but only for example for purposes of maintenance or replacement at the end of life, it is preferable that the means for positioning and holding in position in a removable manner second self-contained electrical power sources 15 in the second location 8 be designed to allow the second self-contained electrical power sources 15 to be placed and removed from the location 8 quickly and easily. As an example, it may be the means described in WO 2020/157094 A2 with reference to FIGS. 9 to 15 which relate to a generating set and to a location of an aerial work platform in order to receive it in a removable manner. The description of WO 2020/157094 A2 made with reference to FIGS. 9 to 15 is incorporated by reference in the present patent application. In particular, it may be provided that all the second self-contained electrical power sources have an identical casing housing their components.

The second self-contained electrical power sources also preferably have a forklift fork passage. This facilitates their placement in or on the second location 8 and their removal by means of a forklift, taking into account the possibly significant weight of these second self-contained electrical power sources 15. In this case, it is advantageous to provide the second self-contained electrical power sources 15 with a locking system which locks them automatically in the second location 8 and which is actuated by at least one of the fork teeth for unlocking. An example of such a locking system is disclosed in patent application FR2008140 filed by the applicant.

A block diagram of the electrical circuit of the telehandler 1 is illustrated by FIG. 3: it is divided into a power circuit 30 and a control circuit 25. The power circuit 30 comprises at least one electric motor for operating the lifting system 5 and allowing the telehandler 1 to move on the ground. In this example, there is a first electric motor 21 dedicated to moving the telehandler 1 on the ground and a second electric motor 23 dedicated to operating the lifting system 5. More particularly, the motor 23 drives a hydraulic pump 25 to supply pressurized fluid to a hydraulic circuit feeding hydraulic actuators to operate the lifting system 5. Although other types may be envisaged, the motors 21 and 23 are preferably AC motors, preferably three-phase AC motors, with regard to the excellent efficiency thereof. It will be understood that the number of electric motors may be varied, for example there may be one dedicated to a front wheel axle and another dedicated to a rear wheel axle, or each of the wheels 3 can be driven by a respective motor.

The motors 21 and 23 are powered by the rechargeable electric battery pack 20—or other main self-contained electrical power source-which is mounted under the cabin 4 and not visible as a result in FIGS. 1 and 2, but which is shown in the following figure by the reference 20. To this end, the power circuit 30 comprises two inverters 22 and 24 for converting the direct current of the battery pack 20 into alternating current suitable for the motor 21 and the motor 23 respectively and making it possible to control the latter. The two inverters 22 and 24 are controlled by on-board electronics 40 of the control circuit 25 based on the control commands entered by the operator at a console control—not shown—installed in the driving cabin 4.

The power circuit 30 also comprises an AC-to-DC voltage converter 31 which acts as a charger for charging the battery pack 20 from a mains supply. According to the case, it may be provided to receive a single-phase and/or three-phase AC voltage, in particular in a range of customary voltages in the countries in which the telehandler 1 is to be used.

The power circuit 30 comprises an electrical connection system for connecting any of the second self-contained electrical power sources 15 thereto. In this case, it comprises a single electrical power connector 35, not shown in FIGS. 1 and 2. The latter is designed to be connected to a corresponding connector 36 of the second self-contained electrical power source 15 when it is received in the second location 8. The second self-contained electrical power sources all have a connector 36 compatible with the connector 35. However, all the individual connection elements of the connector 35 are not necessarily used for all the second self-contained electrical power sources 15 since they may have a different number of electrical power lines, in particular according to whether it delivers a direct current, a single-phase alternating current or a three-phase alternating current.

In this embodiment, the telehandler 1 is designed to receive and manage any one of at least five different second self-contained electrical power sources, namely:
a generator unit 15a comprising an internal combustion engine and delivering a single-phase AC voltage,
a hydrogen fuel cell 15b delivering a DC voltage,
a pack of rechargeable electric batteries 15c distinct from the battery pack 20,
an assembly 15d formed by a pack of rechargeable electric batteries distinct from the battery pack 20 and an associated electric charger for recharging them from a mains supply and which are therefore housed in a common casing in contrast to the battery pack 15c forming a second self-contained electrical power source without an associated electric charger and which is therefore to be recharged by an independent electric charger, and
a solar panel module 15e.

Thus, it is possible to use whichever of the second self-contained electrical power sources is most adapted according to the circumstances, for example depending on whether the telehandler is used outdoors or indoors or depending on the locally available power source. This provides greater versatility and adaptability to the telehandler 1.

It will be understood that this set of second self-contained electrical power sources 15 can be varied and comprise other self-contained electrical power sources, for example a gas turbine generating set, or a generating set delivering a three-phase voltage.

The onboard electronics 40 is provided to manage the second self-contained electrical power source 15 present in the second location 8 at choice according to a first so-called charge mode or according to a second so-called boost mode. In the so-called charge mode, the second self-contained electrical power source serves to recharge the battery pack 20 and contributes only little to supplying the motors 21 and 23. In particular, the onboard electronics may be provided to adapt the load curve of the battery pack 20 according to that of the second self-contained electrical power sources that is received in the second location 8, for example by controlling the converter 31 accordingly. In the so-called boost mode, the motors 21 and 23 can be supplied simultaneously from the battery pack 20 and from the second self-contained electrical power source 15, which makes it possible to operate with cumulative power supplied by the battery pack 20 and the second self-contained electrical power source 15. In the so-called boost mode, the second self-contained electrical power source 15 provides a higher power, for example at least twice, relative to the so-called charge mode. Provision may be made for the operator to be able to select the so-called charge mode or the so-called boost mode at the control console. Alternatively, the onboard electronics 40 may be provided to automatically apply one or the other of the modes, for example depending on the power demanded by the motors 21 and 23. According to another variant, the telehandler 1 may be provided to be able to implement only the so-called charge mode or, alternatively, only the so-called boost mode.

It will be understood that, in any case, the telehandler 1 is designed to operate by means of the battery pack 20, even in the absence of a second self-contained electrical power source in the location 8. Indeed, the battery pack 20 is the main electrical power source of the telehandler 1 while the second self-contained electrical power sources 15 are auxiliary optional sources.

Given the variety of second self-contained electrical power sources, a system for adapting the electrical characteristics of the energy supplied by the latter may be provided.

In this embodiment, the second self-contained electrical power sources 15b, 15b, 15b and 15e each provide a DC voltage at a level corresponding to that of the battery pack 20. There is no need to adapt the voltage for the latter.

On the other hand, the generating set 15a supplies a single-phase AC voltage, or alternatively a three-phase AC voltage. This is then converted to DC voltage. This conversion can be carried out by the converter 31. Alternatively, a separate converter may be provided.

The on-board electronics 40 may be designed to cause the energy supplied by the second self-contained electrical power source 15 to be adapted in this way or not for example by controlling a switch 32 to selectively connect the connector 35 to the converter 31 or to the power circuit 30 by by-passing the converter 31.

Alternatively, if certain second self-contained electrical power sources 15 provide a DC voltage substantially different from that of the battery pack 20, the telehandler 1 may comprise a DC-DC converter for performing a voltage adaptation of the second self-contained electrical power source to that of the power circuit 30 and of the battery pack 20.

Furthermore, some of the second self-contained electrical power sources 15 may be provided to be controlled by the onboard electronics 40 of the telehandler 1. In our example, this is the generating set 15a which comprises a start-up and stop function.

For this purpose, the onboard electronics 40 is connected to control with the generating set 15a—or other relevant self-contained electrical power second source—when it is mounted in the second location 8. In our example, this is a wired connection provided with a connector 41 separate from the power connector 35. Alternatively, the two connectors 35 and 41 are combined in one. According to another embodiment, it may be a wireless communication link.

In this way, the on-board electronics 40 cooperates with electronics integrated in the generating set 15a to control the start-up and shut-down of the generating set 15a.

As emerges from the foregoing, the second self-contained electrical power sources 15 may be subjected to specific management by the onboard electronics 40 such as, for example, the application of a specific load curve to load the battery pack 20, the adaptation of the characteristics of the electrical power that they supply or also the control of functions specific to some of them, such as the start-up and shut-down of the generating set 15a, or even other functions. To this end, an identification system is provided that allows the on-board electronics 40 to know which of the second self-contained electrical power sources 15 is received in the second location 8 and connected to the connector 35. The onboard electronics 40 contains in memory the management rules specific to each of the second self-contained electrical power sources 15.

In an advantageous embodiment, this identification system uses the control link connected to the connector 41 which is preferably made in the form of a data communication link, for example a CAN bus. Each of the second self-contained electrical power sources 15a to 15e comprises integrated electronics designed to provide identification data of this second self-contained electrical power source to the onboard electronics 40. These identification data may for example comprise the mark, the model and the serial number of the second self-contained electrical power source 15. This data communication link is also used to send commands from the on-board electronics 40 to the integrated electronics of the second self-contained electrical power source 15 such as the start-up and shut-down commands of the generating set 15a.

The data communication link may also be used by the integrated electronics of the second self-contained electrical power source 15 to send any information, such as malfunction alarms, to the onboard electronics 40.

Obviously, this data communication link is not used to send commands from the onboard electronics 40 in the case where the second self-contained electrical power source 15 concerned has no controllable functionality as may be the case of the second sources 15c, 15d and 15e.

Alternatively, the identification system may be distinct from the control link. It may for example be implemented on the basis of a transponder that is fitted to each of the second self-contained electrical power sources 15. The identification data recorded in the transponder are read by a suitable reader which is arranged at the second location 8 and which is connected to the onboard electronics 40. In another example, the identification system may be of optical or inductive nature with sensors provided at the location 8 to cooperate with coding tabs arranged on the housing of each second self-contained source electrical power 15 and which identify the latter.

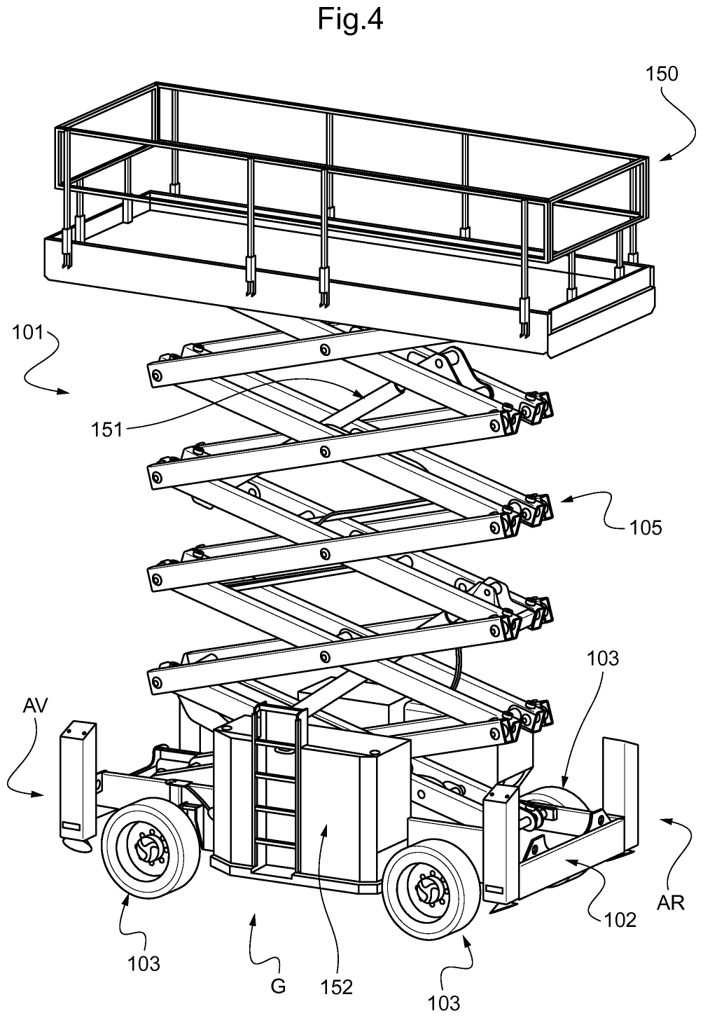

It will be understood that the invention is applicable to any kind of other machines for lifting people or loads of the self-propelled type such as, for example, aerial work platforms. FIGS. 4 to 6 illustrate the case of a scissor lift 101 according to one embodiment of the invention. The scissor lift 101 comprises a chassis 102 and a working platform 150 that is supported by a scissor lift mechanism 105 which is itself mounted on the chassis 102. The working platform 150 conventionally comprises a floor and a guardrail and is designed to receive persons on board, and possibly equipment. The scissor lift mechanism 105 is known per se. It comprises beams articulated at their centers in the manner of scissors, these scissor mechanisms being mounted one above the other by their ends which are pivotally connected in order to be able to fold and extend in height. One or more hydraulic cylinders 151 allow the scissor lift mechanism 105 to extend or fold to raise the working platform 150 to the desired work height and lower it on the chassis 102.

The chassis 102 is provided with wheels 3, in this case two at the front and two at the rear, via which the chassis 102 rests on the ground and which make it possible to move the aerial work platform 101 on the ground. As can be seen in the figures, the front side of the aerial work platform 101 is designated AV, the rear side AR, the left side G and the right side D.

The power circuit of the aerial work platform 101 may be similar to that of FIG. 3 of the telehandler 1. The battery pack 20 and the converter 31 may be arranged on a first lateral side of the chassis 102 relative to the scissor lift mechanism 105, i.e. on the left side G in our example. They are preferably housed inside a cowling 152 visible in FIG. 4.

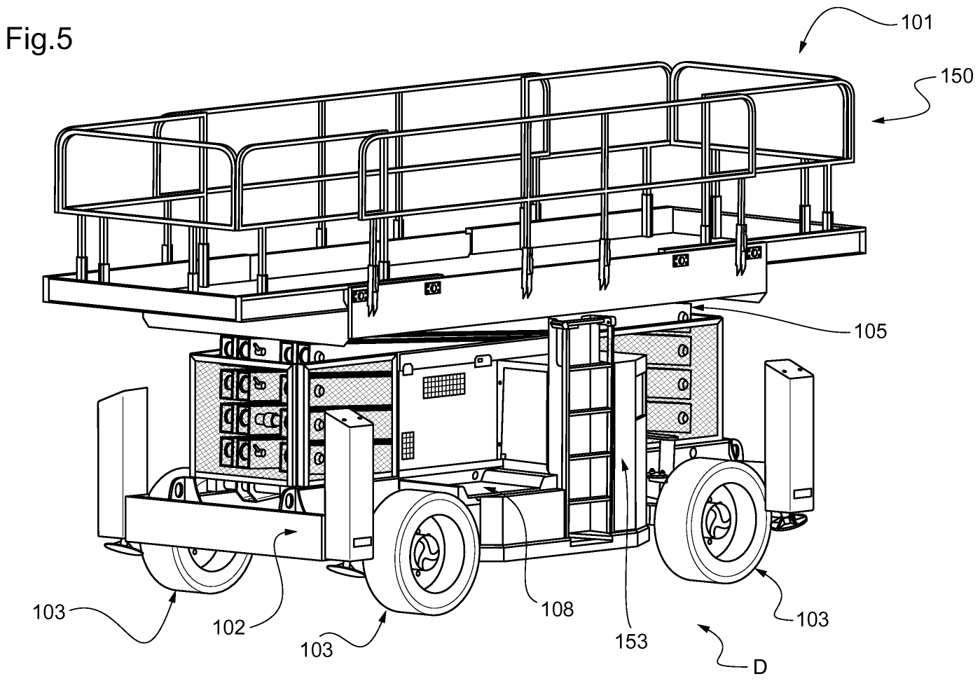

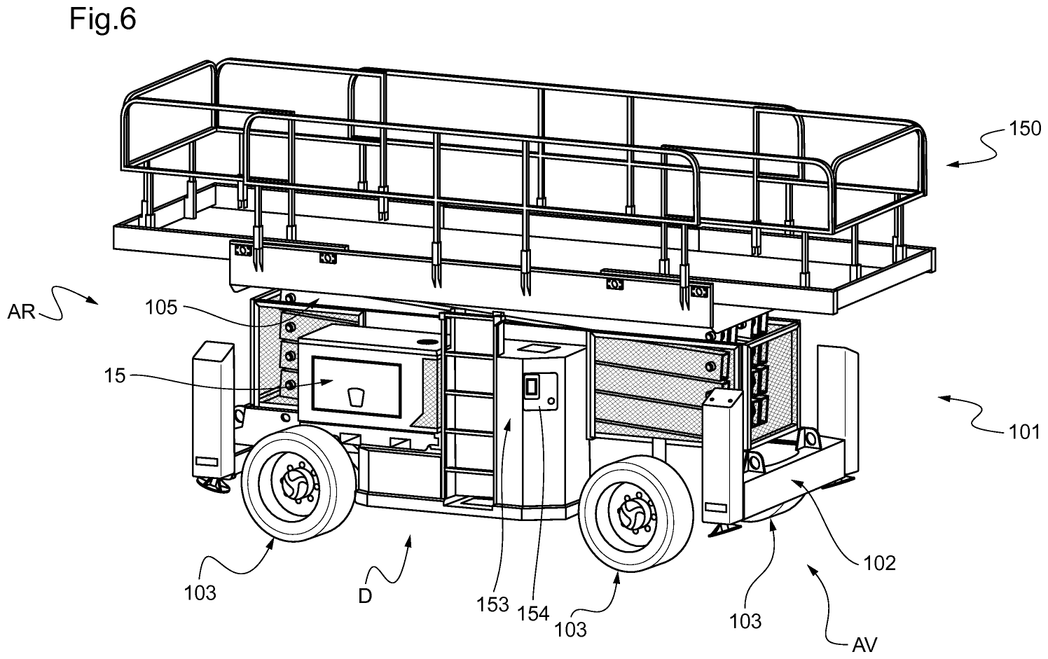

The electric motor 23 and the hydraulic pump 25 may be arranged on the opposite lateral side of the chassis 102 relative to the scissor lift mechanism 105, i.e. on the right side D in our example. They are preferably housed inside a cowling 153 visible in FIGS. 5 and 6. Other components may be housed therein such as for example a hydraulic distributor and the onboard electronics 40. A control console 154 can also be arranged at the level of the cowling 153 so as to be accessible from the outside of the cowling 153. Of course, another control console which is fixed or removable may classically be provided on board the work platform 150 which allows an operator on board the latter to control the lifting or lowering of the working platform 150 and the movement on the ground of the scissor lift 101.

Since these components are less bulky than the battery pack 20, a location 108 is provided on this lateral side of the chassis 102 for the removable mounting of any second self-contained electrical power source to be chosen from a plurality of different second self-contained electrical power sources 15. FIG. 5 shows the location 108 in the absence of a second self-contained electrical power source installed therein. FIG. 6 shows a second self-contained electrical power source 15 received in the location 108.

It will be understood that the description made in the context of the telehandler 1 of FIGS. 1 to 3 with regard to the second self-contained electrical power sources 15 and the way in which they are managed by the telehandler 1 also applies in the case of the aerial work platform 101

It will be understood that the invention can also be applied to aerial work platforms other than those with a scissor lift mechanism. In particular, it is applicable to aerial work platforms having a telescopic mast mounted tiltably on a turret mounted in turn on a chassis. The telescopic mast can be mounted about a horizontal axis directly on the turret or by arms articulated to one another and providing height deployment capability, one end of a lower arm being pivotally mounted about a horizontal axis on the turret and the telescopic mast being pivotally mounted about a horizontal axis at one end of an upper arm.

More generally, the present invention is not limited to the examples and embodiments described and shown, but it is capable of numerous variants accessible to those skilled in the art.

1-20. (canceled)

21. A person or load lifting machine, comprising:
a system for lifting persons or loads,
an electric power circuit comprising:
at least one electric motor for actuating the lifting system and moving the lifting machine on the ground, and
at least a first self-contained electrical power source received in a first location of the lifting machine,
the lifting machine being provided to operate by being powered solely by the first self-contained electrical power source,
wherein the lifting machine further comprises:
a second location distinct from the first location and provided to removably receive a second self-contained electrical power source distinct from the first electrical power source which second self-contained electrical power source is selectable from a plurality of different second self-contained electrical power sources not exclusively consisting of generating sets and not exclusively consisting of electrical power storage devices,
an electrical connection system adapted to connect any one of the plurality of second self-contained electrical power sources thereto when received in the second location so as to enable the second self-contained electrical power source to supply electric power to the power circuit,
an identification system provided to identify which of the plurality of second self-contained electrical power sources is received in the second location, and
onboard electronics provided to manage the supply of electrical power to the power circuit by the second self-contained electrical power source depending on the second self-contained electrical power source identified by the identification system.

22. The machine according to claim 21, wherein at least one of the second self-contained electrical power sources is designed to output a DC voltage and at least one other of the second self-contained electrical power sources is designed to output an AC voltage.

23. The machine according to claim 22, further comprising an electrical adaption system for adapting electrical characteristics of the electrical energy supplied to the power circuit by at least one of the second self-contained electrical power sources when connected to the electrical connection system, the electrical adapting system comprising at least one AC-DC converter and at least one DC-DC converter.

24. The machine according to claim 21, further comprising an electrical adaption system for adapting electrical characteristics of the electrical energy supplied to the power circuit by at least one of the plurality of the second self-contained electrical power sources when connected to the electrical connection system.

25. The machine according to claim 24, wherein the electrical adapting system comprises at least one DC-DC converter.

26. The machine according to claim 21, wherein the identification system comprises a data communication device adapted to establish a data communication link with any one of the plurality of second self-contained electrical power sources when received in the second location, the on-board electronics being provided to cooperate with the data communication device so as to obtain from the second self-contained electrical power source identification data thereof.

27. The machine according to claim 21, which is provided to be able to charge the first self-contained electrical power source from electric power supplied by the second self-contained electrical power source and which is provided to be able to supply the at least one electric motor simultaneously from the first self-contained electrical power source and the second self-contained electrical power source,
wherein:
the machine is provided to allow an operator to choose between charging the first self-contained electrical power source with electric power supplied by the second self-contained electrical power source and supplying the at least one electric motor simultaneously from the first self-contained electrical power source and the second self-contained electrical power source, or
the onboard electronics is designed to automatically choose between charging the first self-contained electrical power source with electric power supplied by the second self-contained electrical power source and supplying the at least one electric motor simultaneously from the first self-contained electrical power source and the second self-contained electrical power source.

28. The machine according to claim 21, wherein the plurality of second self-contained electrical power sources comprises a fuel cell and/or a solar energy panel.

29. The machine according to claim 21, wherein the second location is designed for cooperating in a same manner with any of the second self-contained electrical power sources to position and removably hold the second self-contained electrical power source in or on the second location.

30. The machine according to claim 21, wherein the electrical connection system comprises a power connector to which any one of the second self-contained electrical power sources can be connected.

31. A set of several different self-contained electrical power sources not exclusively consisting of generating sets and not exclusively consisting of electrical power storage devices, each of the self-contained electrical power sources being provided to be received in the second location of a same person or load lifting machine according to claim 21 and to be connected to the electrical connection system of the person or load lifting machine as a said second self-contained electrical power source.

32. The set according to claim 31, wherein each of the self-contained electrical power sources is arranged for being identifiable by the identification system of the person or load lifting machine when the second self-contained electrical power source is received in the second location of the person or load lifting machine.

33. The set according to claim 31, wherein at least one of the second self-contained electrical power sources is designed to output a DC voltage and at least one other of the second self-contained electrical power sources is designed to output an AC voltage.

34. The set according to claim 31, wherein at least one of the second self-contained electrical power sources is designed to output a DC voltage, at least one other of the second self-contained electrical power sources is designed to exclusively output a single-phase AC voltage and at least one other of the second self-contained electrical power sources is designed to output a three-phase AC voltage.

35. The set according to claim 31, comprising several self-contained electrical power sources outputting each a different DC voltage.

36. The set according to claim 31, which comprises one or more of the following self-contained electrical power sources: a fuel cell and/or a solar energy panel.

37. A method of operating a person or load lifting machine according to claim 21, comprising:
providing a set of several different self-contained electrical power sources for selective use of any one of them with the person or load lifting machine as a said second self-contained electrical power source, the set of several different self-contained electrical power sources not exclusively consisting of generating sets and not exclusively consisting of electrical power storage devices, each of the self-contained electrical power sources being provided to be received in the second location of the person or load lifting machine and to be connected to the electrical connection system of the person or load lifting machine as a said second self-contained electrical power source.

38. The method according to claim 37, wherein each of the self-contained electrical power sources is arranged for being identifiable by the identification system of the person or load lifting machine when the second self-contained electrical power source is received in the second location of the person or load lifting machine.

39. The method according to claim 37, wherein at least one of the second self-contained electrical power sources is designed to output a DC voltage and at least one other of the second self-contained electrical power sources is designed to output an AC voltage.

40. The set according to claim 37, which comprises one or more of the following self-contained electrical power sources: a fuel cell and/or a solar energy panel.
